(19) United States
(12) Patent Application Publication
(10) Pub. No.: US 2014/0129465 A1
(43) Pub. Date: May 8, 2014

(54) TALENT ACQUISITION PIPELINE

(71) Applicant: SAP AG, Walldorf (DE)

(72) Inventors: Tanja Baeck, Wiesloch (DE); Elmar Paul, Angelbachtal (DE); S.M. Fazlul Hoque, Mannheim (DE); Bertram Wiest, Heidelberg (DE); Silke Storch, Rauenberg (DE)

(73) Assignee: SAP AG, Walldorf (DE)

(21) Appl. No.: 13/672,570

(22) Filed: Nov. 8, 2012

(51) Int. Cl. G06Q 10/00

(52) U.S. Cl. CPC G06Q 10/1053
USPC 705/321

(57) ABSTRACT

A talent acquisition pipeline can be provided for managing candidates for a job opening. The talent acquisition pipeline comprises a plurality of stages. Information can be displayed along with the talent acquisition pipeline, including a count of candidates associated with the stages and/or target values associated with the stages. Candidates can be moved between stages. Stage-specific actions can be selected to perform various actions related to the candidates for a selected stage. A graphical user interface can be provided depicting a talent acquisition pipeline and a list of candidates associated with a selected stage of the pipeline.

### BACKGROUND

The hiring process for qualified employees is becoming increasingly competitive. In addition, qualified candidates often do not actively apply for new positions. Therefore, it can be a challenge for a company to recruit qualified candidates for open positions.

The hiring process can be difficult and time consuming. Typically, a company posts a job opening and waits for candidates to apply. The job opening could be posted, for example, on-line, in a newspaper, etc. A person within the company, such as a hiring manager, typically receives submissions from candidates interested in the position, manually reviews and organizes the candidates, conducts interviews, and ultimately makes job offers. This process of posting job openings, receiving candidate submissions, manually reviewing, screening, and organizing the candidates, can be time consuming and difficult, particularly when there are many applicants for a position, or when there are many positions to fill.

Furthermore, it is often the case that qualified candidates do not actively apply for new positions. Therefore, even if a company posts a job opening, qualified candidates may not be aware of the job opening.

Therefore, there exists ample opportunity for improvement in technologies related to managing candidates for job openings.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

For example, a talent acquisition pipeline (talent pipeline) can be provided for managing candidates for a job opening (a job position or position). The talent acquisition pipeline comprises a plurality of stages. Information can be displayed along with the talent acquisition pipeline, including a count of candidates associated with the stages and/or target values associated with the stages. Candidates can be moved between stages (e.g., by a user, such as a recruiter, sourcer, or hiring manager). Stage-specific actions can be selected to perform various actions related to the candidates for a selected stage.

As another example, a method can be provided for managing candidates using a talent acquisition pipeline. The method comprises displaying, to a user, a talent pipeline, where the talent pipeline comprises a plurality of stages, receiving, from the user, a selection of a stage from the displayed plurality of stages of the talent pipeline, in response to the selection of the stage, displaying, to the user, a list of candidates, where the list of candidates are associated with the selected stage, and receiving, from the user, an action to move a selected candidate from the list of candidates to a different stage of the plurality of stages.

As another example, a method can be provided for managing candidates using a talent acquisition pipeline. The method comprises displaying, to a user, a talent pipeline, where the talent pipeline comprises a plurality of stages, receiving, from the user, a selection of a stage from the displayed plurality of stages of the talent pipeline, in response to the selection of the stage, displaying, to the user, a list of candidates, where the list of candidates are associated with the selected stage, and in response to the selection of the stage, displaying, to the user, a user interface element for performing a stage-specific action for the displayed list of candidates, where the stage-specific action is associated with the selected stage.

As another example, a user interface can be provided for managing candidates using a talent acquisition pipeline. The user interface comprises a first user interface area displaying the talent pipeline, where the talent pipeline comprises a plurality of stages, and where displaying the talent pipeline comprises displaying the plurality of stages. The user interface also comprises a second user interface area displaying a list of candidates. When a stage of the displayed plurality of stages is selected, the second user interface area displays a list of candidates that are associated with the selected stage, and user interface elements are displayed for performing stage-specific actions for the list of candidates.

As described herein, a variety of other features and advantages can be incorporated into the technologies as desired.

### BRIEF DESCRIPTION OF THE DRAWINGS

FIG. 1 is a diagram depicting an example talent acquisition pipeline with six or seven stages.

FIG. 2 is a diagram depicting an example talent acquisition pipeline including numbers of candidates.

FIG. 3 is a diagram depicting an example talent acquisition pipeline including target values.

FIG. 4 is a diagram depicting an example user interface for managing a talent acquisition pipeline and a list of candidates for a selected Long List stage.

FIG. 5 is a diagram depicting an example user interface for managing a talent acquisition pipeline and a list of candidates for a selected Short List stage.

FIG. 6 is a diagram depicting an example user interface for managing a talent acquisition pipeline, including a list of candidates for a selected stage and job information.

FIG. 7 is a flowchart of an example method for managing a candidates using a talent acquisition pipeline.

FIG. 8 is a flowchart of another example method for managing a candidates using a talent acquisition pipeline.

FIG. 9 is a diagram of an example computing system in which some described embodiments can be implemented.

FIG. 10 is an example cloud computing environment that can be used in conjunction with the technologies described herein.

### DETAILED DESCRIPTION

### Example 1

### Overview

The following description is directed to techniques and solutions for managing candidates (talents) using a talent acquisition pipeline (talent pipeline). A talent acquisition pipeline divides the process of identifying and hiring (including, for example, sourcing) candidates into a plurality of stages. The talent acquisition pipeline can display information associated with one or more stages of the pipeline. For example, the talent acquisition pipeline can display a current count of candidates associated with one or more of the stages. The talent acquisition pipeline can also display a target number (e.g., a goal) of candidates for one or more of the stages.

Stages of the talent acquisition pipeline can be selected. For example, a user of a graphical user interface can select on a stage of the pipeline (e.g., by clicking, tapping, or otherwise selecting the stage, or by using another type of user interface control). Selecting the stage of the pipeline displays candidates associated with (e.g., assigned to) the selected stage. For example, displaying the candidates associated with a selected stage can comprise displaying a list of candidates and their associated details (e.g., name, current job information, skills and experience, match information, stage-specific actions that can be performed for the candidate, etc.).

Actions can be performed using the talent acquisition pipeline and associated candidate information. For example, a user interface can display the talent acquisition pipeline and a list of candidates along with stage-specific actions. The stage-specific actions can be selected by a user to perform actions that are relevant to the selected stage and the list of candidates. For example, if the selected stage is a “Long List” stage, then the list of candidates can be displayed along with stage-specific actions to contact the candidates (e.g., call, email, etc.), to move candidates to the “Short List” stage, to move candidates to the “Applicants” stage, to delete candidates from the pipeline, to move candidates back to the “Search Results” stage, etc.

Candidates can be moved between stages. For example, a user can select a candidate from a list of candidates and move the selected candidate to a different stage. The user can move the candidate by dragging and dropping the candidate (a drag-and-drop action) from the list to a different stage of the displayed pipeline using a graphical user interface. The user can also move the selected candidate using another type of user interface control (e.g., by selecting the user and selecting a move button or move selection from a drop-down list).

### Example 2

### Talent Acquisition Pipeline

In any of the examples herein, a talent acquisition pipeline can be provided for managing candidates for job openings. The talent acquisition pipeline comprises a plurality of stages that group candidates (e.g., during the hiring process). The talent acquisition pipeline provides for quick and efficient visualization of the status of candidates for a job opening. The talent acquisition pipeline also provides for efficient selection of candidates, moving candidates between stages, performing actions related to the candidates (e.g., sending communications, moving between stages, etc.).

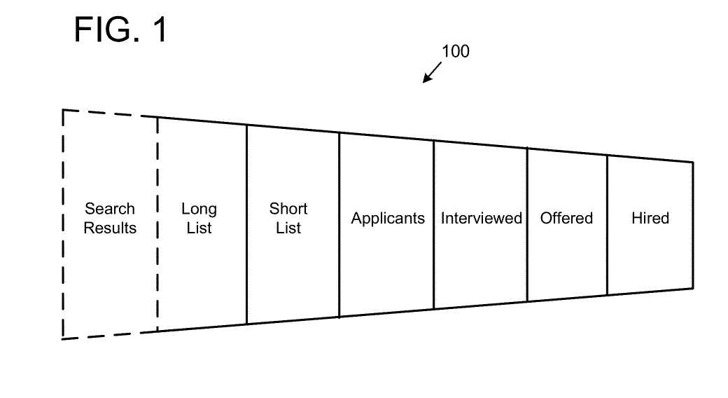

FIG. 1 is a diagram depicting an example talent acquisition pipeline 100 with six or seven stages. The talent acquisition pipeline 100 includes an optional “Search Results” stage. The Search Results stage groups candidates that have been identified (e.g., as potential matches) for the job opening. For example, an automated computer search can be performed to identify candidates (e.g., candidates that match one or more criteria, such as one or more job requirements). The automated search can be performed based on publicly available potential candidate information, such as information available from profile sites, social and business networking sites (e.g., Facebook and LinkedIn), job sites, etc. Potential candidates can also be added (e.g., manually added) to the Search Results stage by a sourcer, recruiter, manager, etc. In some implementations, the Search Results stage is part of the talent acquisition pipeline, and in other implementations, the Search Results stage is managed outside, or separate from, the talent acquisition pipeline.

The “Long List” stage of the talent acquisition pipeline 100 groups candidates that have been identified for further action. For example, a recruiter or sourcer can review the candidates in the Search Results stage. Those candidates that the recruiter or sourcer would like to investigate further can be moved to the Long List. For example, a recruiter or sourcer can research candidates in the Long List and/or contact (e.g., call and/or email) candidates in the Long List to determine whether they are interested in the position. The candidates can also be selected automatically (e.g., based on qualifications) for movement from the Search Results stage to the Long List stage.

The “Short List” stage of the talent acquisition pipeline 100 groups candidates, for example, that have been pre-qualified (e.g., by the recruiter), candidates that have indicated interest in the position, and/or candidates that are otherwise of particular interest (e.g., are well matched to the position). For example, a recruiter can research and/or contact candidates in the Long List. Based on the research and/or contact, the recruiter can move candidates to the Short List. The candidates in the Short List can be candidates that are being seriously considered for the position. For example, a recruiter can contact candidates in the Short List and request that the candidates apply for the position.

In some implementations, a “Reviewed” stage is included in the talent acquisition pipeline 100 after the Short List stage. For example, the Reviewed stage can group candidates that have gone through additional review after being moved to the Long List or Short List. Candidates in the Reviewed stage can be considered qualified (e.g., pre-qualified) to apply for the position.

The “Applicants” stage of the talent acquisition pipeline 100 groups candidates that have applied for the job. For example, a candidate that is in the Short List or Long List stage can be contacted about the job opening. In response, the candidate can apply for the position (e.g., verbally apply and/or submit an application). For example, the candidate can complete a web-based job application form. Once the candidate has applied, the candidate can be moved to the Applicants stage. Alternatively, an individual that is not in the Short List or Long List stage may apply for the job. For example, the individual may see a job posting (e.g., on an internal or external web site) and apply.

The “Interviewed” stage of the talent acquisition pipeline 100 groups candidates that have interviewed for the position. For example, a candidate that is in the Applicants stage can be contacted by a recruiter to schedule an interview. Once the interview has been requested, scheduled, and/or conducted, the candidate can be moved to the Interviewed stage.

The “Offered” stage of the talent acquisition pipeline 100 groups candidates that have been made a job offer. For example, a candidate in the Interviewed stage can be selected and a job offer can be sent to the candidate. Once the job offer has been made and/or accepted, the candidate can be moved to the Offered stage.

The “Hired” stage of the talent acquisition pipeline 100 groups candidates that have been hired. For example, a candidate that is in the Offered stage can accept the job offer. Once accepted, the candidate can be moved to the Hired stage.

A talent acquisition pipeline can have more stages, fewer stages, and/or different stages than the stages depicted in FIG. 1. For example, a talent acquisition pipeline can also comprise a “Handoff” stage (e.g., after the Search Results stage or Long List stage) for handing off candidates from a sourcer (e.g., a person in charge of searching for candidates) and a recruiter.

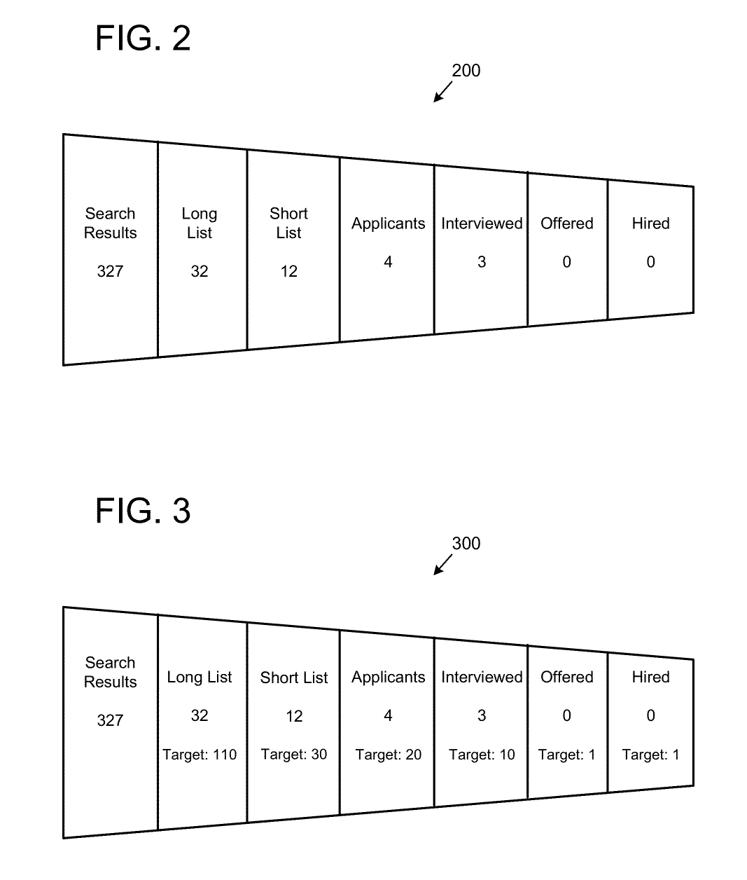

FIG. 2 is a diagram depicting an example talent acquisition pipeline 200 that displays the number of candidates associated with the stages of the pipeline. In the example pipeline 200, the Search Results stage includes 327 candidates, the long List stage includes 32 candidates, the Short List includes 12 candidates, the Applicants stage includes 4 candidates, the Interviewed stage includes 3 candidates, the Offered stage includes zero candidates, and the Hired stage includes zero candidates.

From the example pipeline 200, a user can see (e.g., via a graphical user interface that visually depicts the pipeline 200 and the number of candidates in each stage) the status of the job search. For example, from the example pipeline 200, a user (e.g., recruiter, sourcer, manager, or someone else that uses the pipeline) can see that 327 candidates were identified (e.g., from an automated search of on-line profile information), that 32 of the candidates were moved to the Long List stage (e.g., were reviewed and determined to be a good fit for the position), that 12 candidates (e.g., candidates from the Long List and/or from the Search Results) were moved to the Short List (e.g., based on additional research and/or communication with the candidate), that 4 candidates (e.g., from the Search Results, Long List, Short List, and/or an outside source) applied for the position, and that 3 candidates interviewed for the position. In this way, the user of the example pipeline 200 can quickly and efficiently evaluate the status of filling the position, what additional action is needed (e.g., evaluate the interview results and make an offer), and how long it might take to complete the process and hire a candidate.

In some implementations, a candidate can only be associated with one stage at a time for a given job opening.

Target values can be set for one or more stages of a talent acquisition pipeline. The target values indicate a target number (e.g., a goal or desired number) of candidates for the corresponding stage. In some implementations, the target value is the recommended number of candidates for the particular stage to fill the job opening within a specified amount of time. The target values can vary depending on a number of factors, including the type of job, the desired time to fill the job, etc. For example, to fill a marketing associate job opening within 60 days, specific target values can be set for the recommended number of candidates for various pipeline stages.

A talent acquisition pipeline can be used for a job opening to be filled by one candidate or by a plurality of candidates. For example, a job opening can be created for a group of two or more candidates (e.g., for a call center team), with a single talent acquisition pipeline grouping all the candidates.

FIG. 3 is a diagram depicting an example talent acquisition pipeline 300 that displays target values for the stages of the pipeline. In the example pipeline 300, the target number of candidates is set to 110 for the Long List stage, 30 for the Short List stage, 20 for the Applicants stage, 10 for the Interviewed stage, one for the Offered stage, and one for the Hired stage. The target values can indicate to a user a recommended number of candidates that should be associated with each stage in order to fill the position within a desired timeframe (e.g., a number of days or months). Using the target values depicted in the example pipeline 300, the user knows that approximately 110 candidates should be selected for the Long List stage, 30 candidates should be selected for the Short List stage, 20 candidates should apply for the position, 10 candidates should be interviewed, and one candidate should be offered the job and hired (e.g., to fill the position in 60 days).

### Example 3

### User Interface for Managing Candidates using a Talent Acquisition Pipeline

In any of the examples herein, a user interface can be provided for managing candidates using a talent acquisition pipeline. The user interface can be presented, for example, as a local application and/or as a remote (e.g., web-based or online) application or service.

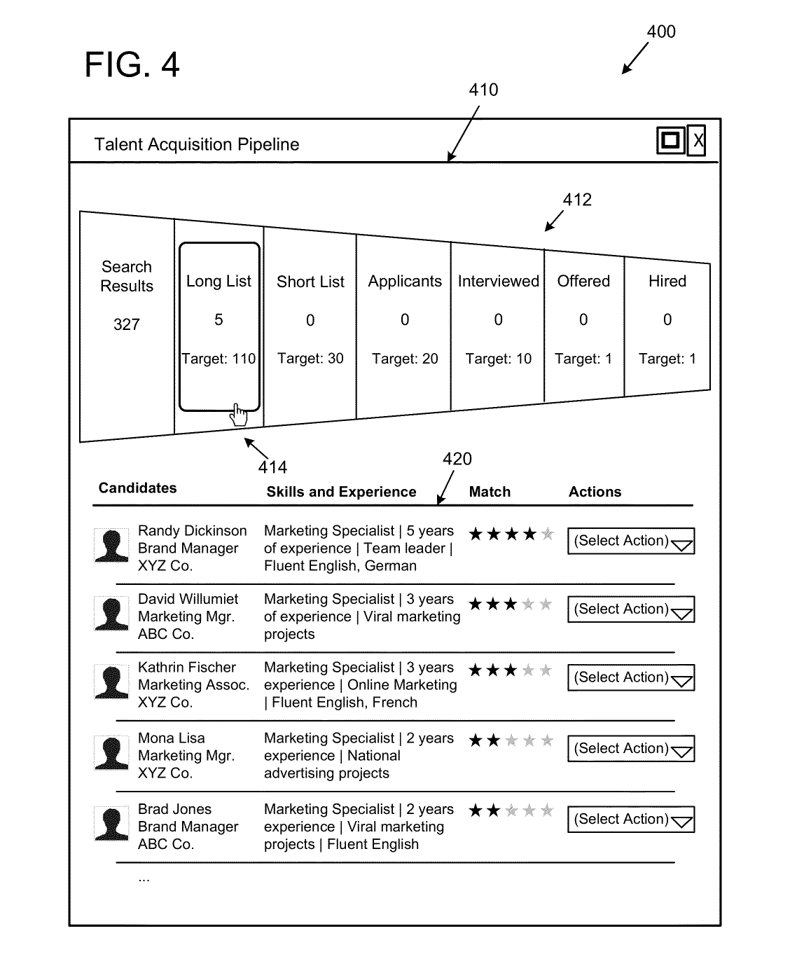

FIG. 4 is a diagram depicting an example user interface 400 for managing candidates using a talent acquisition pipeline. The user interface 400 includes a first user interface area 410 depicting a talent acquisition pipeline 412. The talent acquisition pipeline 412 has seven stages. Depending on implementation details, the talent acquisition pipeline can have more, fewer, and/or different stages than those depicted at 412.

In the user interface 400, the Long List stage of the talent acquisition pipeline 412 has been selected 414 by a user. In response to the selection 414 of the Long List stage, a second user interface area 420 is displayed. The second user interface area 420 contains a list of candidates that are associated with the selected Long List stage. In the example user interface 400, the Long List has five candidates. Therefore, when the Long List stage is selected, the five candidates are listed in the second user interface area 420.

The list of candidates depicted in the second user interface area 420 includes candidate information (name, position, etc.), skills and experience (e.g., a summary of job experience and/or other skills), a match indication, and actions. The match indication can indicate how closely the candidate matches the job opening. The match indication can be displayed, for example, as a number of stars (e.g., out of a possible five stars), as a percentage, etc. One or more match indications can be displayed. For example, a match indicator can be displayed for matching a target profile and/or a match indicator can be displayed ranking top performers among the candidates.

The actions displayed with the list of candidates in the second user interface area 420 can include stage-specific actions for managing the candidates depending on which pipeline stage of the talent acquisition pipeline 412 is selected. In the example user interface 400, the Long List stage is selected 414. Based on the selected Long List stage, the actions can comprise stage-specific actions, such as an action to contact a selected candidate (e.g., call or email the candidate to determine whether the candidate is interested in the position or would like to submit an application), an action to move a selected candidate to the Short List (e.g., based on further research or review, or based on communication with the candidate), an action to move a selected candidate back to the Search Results stage, and an action to remove the candidate from the pipeline (e.g., due to the candidate indicating a lack of interest in the position). The actions can be performed by a user selecting a user interface element, such as a drop-down list, buttons, or other user interface elements.

Stage-specific actions are provided depending on the selected stage of the target acquisition pipeline. For example, stage-specific actions for a Search Results stage can include: move candidate to Long List, move candidate to Short List, and remove candidate. Stage-specifications for a Long List stage can include: move candidate to Search Results, move candidate to Short List, move candidate to Applicants, contact candidate, and remove candidate. Stage-specifications for a Short List stage can include: move candidate to Search Results, move candidate to Long List, move candidate to Applicants, contact candidate, and remove candidate. Stage-specifications for an Applicants stage can include: move candidate to Short List, move candidate to Interviewed (e.g., schedule or conduct interview), and remove candidate. Stage-specifications for an Interviewed stage can include: move candidate to Offered (e.g., make offer to candidate), and remove candidate. Stage-specifications for an Offered stage can include: move candidate to Hired, and remove candidate

Some stage-specific actions are applicable to more than one stage, and other stage-specific actions are only available when a specific stage is selected. For example, in some implementations, a send offer stage-specific action is only available to candidates associated with an Interviewed stage (e.g., when the Interviewed stage is selected). In some implementations, a schedule interview stage-specific action is only available to candidates associated with an Applicants stage (e.g., when the Applicants stage is selected). In some implementations, a hired stage-specific action is only available to candidates associated with an Offered stage (e.g., when the Offered stage is selected).

Candidates can also be moved between stages in other ways. For example, a user of the user interface 400 can select a candidate from the list displayed in the second user interface area 420 and move the selected candidate to a different stage of the talent acquisition pipeline 412. The movement can be accomplished using a drag-and-drop action. For example, the user can select the candidate and drag the candidate to a different stage (e.g., drag candidate Randy Dickinson from the second user interface area 420 to the Short List stage of the talent acquisition pipeline 412 depicted in the first user interface area 410).

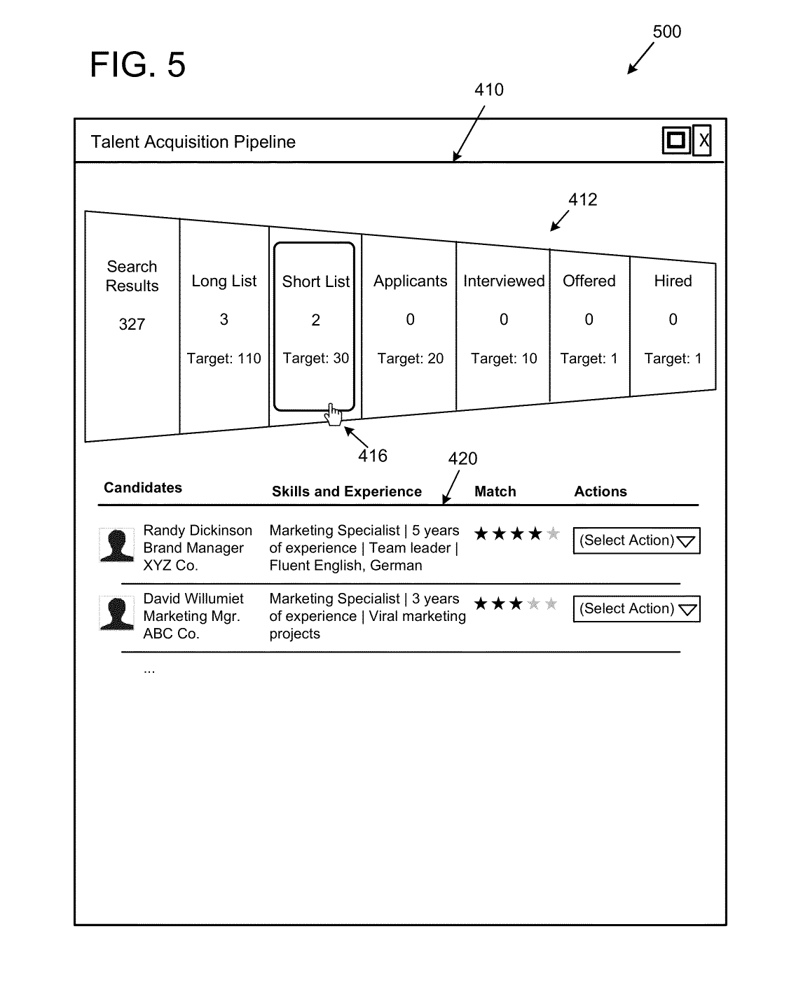

FIG. 5 is a diagram depicting an example user interface 500 for managing candidates using a talent acquisition pipeline. In the example user interface 500, the Short List stage of the talent acquisition pipeline 412 is selected 416. In response to the selection of the Short List, the second user interface area 420 displays a candidate list listing candidates associated with the Short List stage. For example, with reference to the Long List candidates depicted in FIG. 4, two of the candidates have been moved from the Long List to the Short List (candidates Randy Dickinson and David Willumiet). The talent acquisition pipeline 412 reflects the movement of candidates by displaying three candidates in the Long List and two in the Short List after the move, as depicted in FIG. 5.

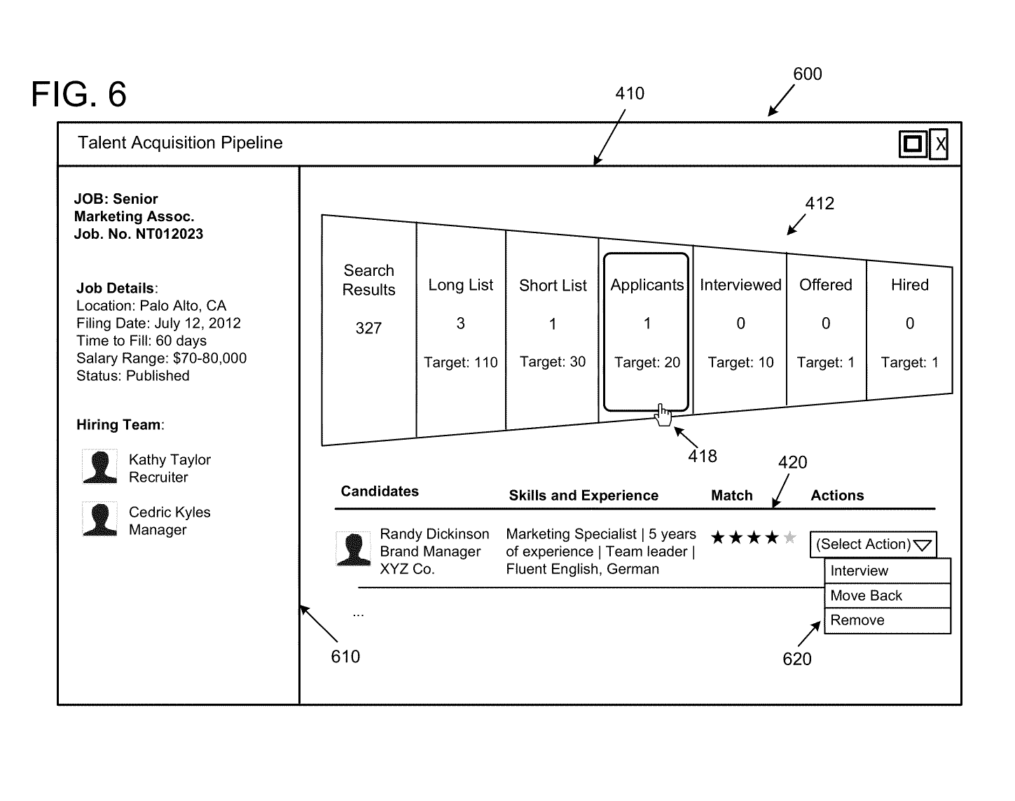

FIG. 6 is a diagram depicting an example user interface 600 for managing candidates using a talent acquisition pipeline. In FIG. 6, the example user interface 600 is expanded to include a job information user interface area 610. The job information user interface area 610 depicts information related to the current job opening (for which the talent acquisition pipeline is displayed). The job information can include a job description, job details, hiring team information, and other information related to the job opening.

FIG. 6 also depicts a user selection 418 of the Applicants stage of the talent acquisition pipeline 412. For example, with reference to the Short List candidates depicted in FIG. 5, one of the candidates has been moved from the Short List to the Applicants stage (candidate Randy Dickinson). The talent acquisition pipeline 412 reflects the movement of the candidate by displaying one candidate in the Short List stage and one in the Applicants stage after the move, as depicted in FIG. 6. For example, a user of the user interface could have contacted candidate Randy Dickinson, accepted an application from Randy for the job opening, and moved Randy from the Short List stage to the Applicants stage (e.g., using a stage-specific action depicted in the second user interface area 420).

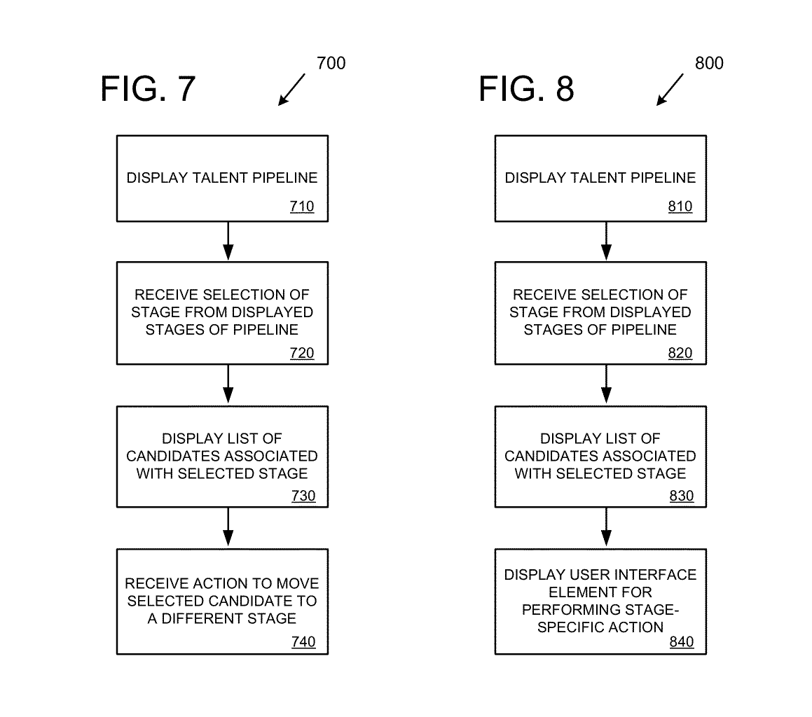

FIG. 7 also depicts a number of example stage-specific actions 720 that can be performed for candidates in the candidate list for the selected stage (in this example, for candidate Randy Dickinson who is associated with the Applicants stage). The example stage-specific actions 720 are an interview stage-specific action (e.g., for contacting Randy Dickinson to schedule an interview), a move back stage-specific action (e.g., for moving Randy Dickinson back to the Short List stage), and a remove stage-specific action (e.g., for removing Randy Dickinson from the talent acquisition pipeline).

### Example 4

### Methods for Managing Candidates Using a Talent Acquisition Pipeline

In any of the examples herein, methods can be provided for managing candidates using a talent acquisition pipeline. FIG. 7 is a flowchart of an example method 700 for managing candidates using a talent acquisition pipeline. The example method 700 can be performed, at least in part, by a computing device. For example, a server environment can provide the method as a web-based or online service to users (e.g., recruiters, sourcers, hiring managers, etc.).

At 710, a talent acquisition pipeline is displayed (e.g., displayed to a user). The talent acquisition pipeline comprises a plurality of stages. In some implementations, the talent pipeline comprises a plurality of the stages depicted in FIG. 1.

At 720, a selection of a stage is received (e.g., from the user) from the displayed stages of the talent acquisition pipeline. For example, the stages can be displayed with associated information, such as counts of candidates associated with one or more of the stages and/or target values associated with one or more of the stages.

At 730, a list of candidates associated with the selected stage is displayed. For example, displaying the list of candidates can comprise displaying candidate information such as: name, position, skills and experience, match score(s), etc. Actions, such as stage-specific actions, can also be displayed and/or received. For example, actions to move a candidate from the displayed list of candidates can be received (e.g., a drag-and-drop action and/or an action selected from a user interface element such as a button or drop-down list).

At 740, an action to move a selected candidate (from the displayed list of candidates) to a different stage (from the currently selected stage) is received. Once the candidate has been moved, the talent acquisition pipeline can display, for example, updated counts of candidates in each of the stages.

FIG. 8 is a flowchart of another example method 800 for managing candidates using a talent acquisition pipeline. The example method 800 can be performed, at least in part, by a computing device. For example, a server environment can provide the method as a web-based or online service to users (e.g., recruiters, sourcers, hiring managers, etc.).

At 810, a talent acquisition pipeline is displayed (e.g., displayed to a user). The talent acquisition comprises a plurality of stages. In some implementations, the talent pipeline comprises a plurality of the stages depicted in FIG. 1.

At 820, a selection of a stage is received (e.g., from the user) from the displayed stages of the talent acquisition pipeline. For example, the stages can be displayed with associated information, such as counts of candidates associated with one or more of the stages and/or target values associated with one or more of the stages.

At 830, a list of candidates associated with the selected stage is displayed (e.g., to the user). For example, displaying the list of candidates can comprise displaying candidate information such as: name, position, skills and experience, match score(s), etc. Actions, such as stage-specific actions, can also be displayed and/or received. For example, actions to move a candidate from the displayed list of candidates can be received (e.g., a drag-and-drop action and/or an action selected from a user interface element such as a button or drop-down list).

At 840, a user interface element is displayed (e.g., to the user) for performing a stage-specific action for the displayed list of candidates. The stage-specific action is an action that is associated with the selected stage (e.g., it is an action that can be performed for candidates associated with the selected stage). The stage-specific action could be an action that is only associated with the selected stage (and not available for use with other stages). For example, the stage-specific action could be a make offer stage-specific action for a selected Interviewed stage. The stage-specific action could also be an action that is present in more than one stage. For example, the stage-specific action could be a “move to applicants” stage specific action where the selected stage is either a Long List stage or a Short List stage.

### Example 5

### Computing Systems

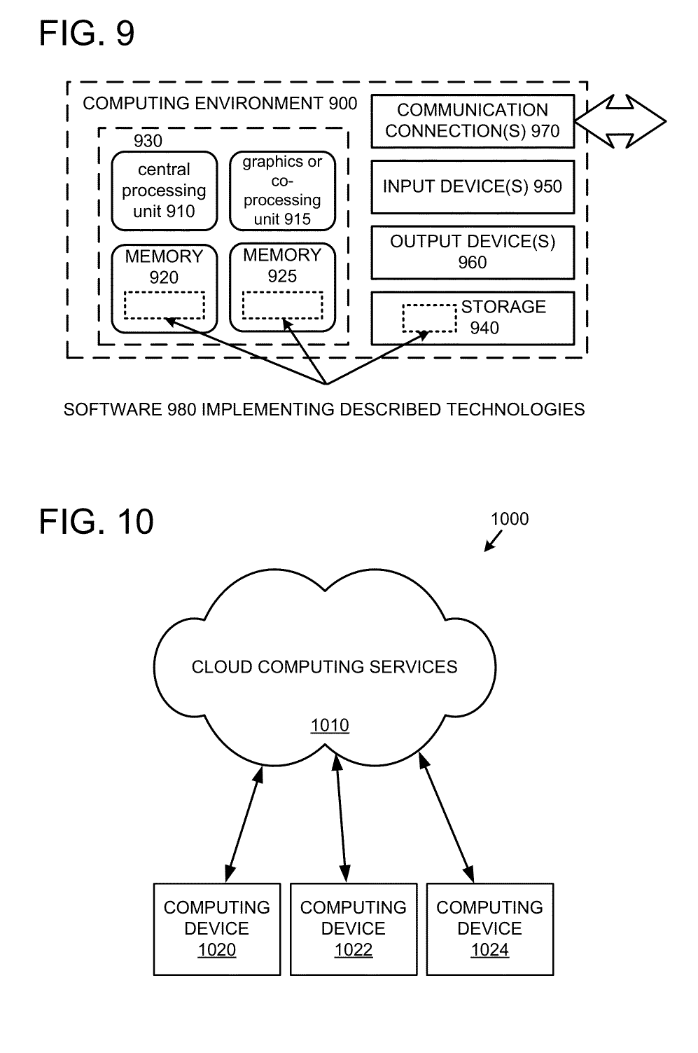

FIG. 9 depicts a generalized example of a suitable computing system 900 in which the described innovations may be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 6

### Cloud Computing Environment

FIG. 10 depicts an example cloud computing environment 1000 in which the described technologies can be implemented. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operators (e.g., data processing, data storage, and the like).

### Example 7

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs such as DVD or CD, volatile memory components (such as DRAM or SRAM), or nonvolatile memory components (such as flash memory or hard drives)). By way of example and with reference to FIG. 9, computer-readable storage media include memory 920 and 925, and storage 940. As should be readily understood, the term computer-readable storage media does not include communication connections (e.g., 970) such as modulated data signals.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing device, for managing candidates using a talent acquisition pipeline, the method comprising:
by the computing device:
displaying, to a user, the talent pipeline, wherein the talent pipeline comprises a plurality of stages;
receiving, from the user, a selection of a stage from the displayed plurality of stages of the talent pipeline;
in response to the selection of the stage, displaying, to the user, a list of candidates, wherein the list of candidates is associated with the selected stage; and
receiving, from the user, an action to move a selected candidate from the list of candidates to a different stage of the plurality of stages.

2. The method of claim 1, wherein the displayed plurality of stages of the talent pipeline comprise:
a long list stage;
a short list stage;
an applicants stage;
an interviewed stage;
an offered stage; and
a hired stage.

3. The method of claim 1, further comprising:
displaying, to the user, a count of candidates associated with each stage.

4. The method of claim 1, further comprising:
displaying, to the user, a target number of candidates associated with one or more of the plurality of stages.

5. The method of claim 1, further comprising:
displaying, to the user, a user interface element for performing one or more stage-specific actions, wherein the one or more stage-specific actions are associated with the selected stage, and wherein the one or more stage-specific actions are selectable by the user for performing actions for candidates from the displayed list of candidates.

6. The method of claim 1, wherein the selected stage is an interviewed stage, the method further comprising;
displaying, to the user, a user interface element for performing a send offer stage-specific action, wherein the send offer stage-specific action is only displayed when the selected stage is the interviewed stage, and wherein the send offer stage-specific action is selectable by the user to send an offer to a candidate from the list of candidates.

7. The method of claim 1, wherein the action to move the selected candidate comprises a drag-and-drop selection by the user to move the candidate from the list of candidates to the different stage of the displayed plurality of stages.

8. A graphical user interface, displayed by a computing device comprising a processing unit, memory, and a display, for managing a talent acquisition pipeline, the user interface comprising:
a first user interface area displaying the talent pipeline, wherein the talent pipeline comprises a plurality of stages, and wherein displaying the talent pipeline comprises displaying the plurality of stages; and
a second user interface area displaying a list of candidates;
wherein when a stage of the displayed plurality of stages is selected, the second user interface area displays a list of candidates that are associated with the selected stage; and
wherein when the stage of the displayed plurality of stages is selected, user interface elements are displayed for performing stage-specific actions for the list of candidates.

9. The user interface of claim 8 wherein the displayed plurality of stages of the talent pipeline comprise:
a long list stage;
a short list stage;
an applicants stage;
an interviewed stage;
an offered stage; and
a hired stage.

10. The user interface of claim 8 wherein the displayed plurality of stages of the talent pipeline comprise:
a search results stage;
a long list stage;
a short list stage;
an applicants stage;
an interviewed stage;
an offered stage; and
a hired stage.

11. The user interface of claim 8 wherein displaying the plurality of stages comprises:
displaying, for each stage of the plurality of stages, a count of candidates associated with the stage.

12. The user interface of claim 8 wherein displaying the plurality of stages comprises:
displaying, for one or more stages of the plurality of stages, a target number of candidates for each of the one or more stages.

13. The user interface of claim 8 wherein when the selected stage is an interviewed stage, the stage-specific actions comprise a send offer stage-specific action, wherein the send offer stage-specific action is only displayed when the selected stage is the interviewed stage, and wherein the send offer stage-specific action is selectable by a user to send an offer to a selected candidate from the list of candidates.

14. The user interface of claim 8 wherein the second user interface area supports user selection of a candidate from the displayed list of candidates, and wherein the second user interface area supports drag-and-drop activity by the user to move the selected candidate from the selected stage to a different stage, of the plurality of stages, displayed in the first user interface area.

15. A system comprising:
memory;
a processing unit; and
one or more computer-readable storage media storing instructions causing the system to perform operations for managing a talent acquisition pipeline, the operations comprising:
displaying, to a user, the talent pipeline, wherein the talent pipeline comprises a plurality of stages;
receiving, from the user, a selection of a stage from the displayed plurality of stages of the talent pipeline;
in response to the selection of the stage, displaying, to the user, a list of candidates, wherein the list of candidates is associated with the selected stage; and
in response to the selection of the stage, displaying, to the user, a user interface element for performing a stage-specific action for the displayed list of candidates, wherein the stage-specific action is associated with the selected stage.

16. The system of claim 15 wherein the displayed plurality of stages of the talent pipeline comprise:
a long list stage;
a short list stage;
an applicants stage;
an interviewed stage;
an offered stage; and
a hired stage.

17. The system of claim 15 wherein the displayed plurality of stages of the talent pipeline comprise:
a search results stage;
a long list stage;
a short list stage;
an applicants stage;
an interviewed stage;
an offered stage; and
a hired stage.

18. The system of claim 15 wherein the operations further comprise:
receiving, from the user, an action to move a selected candidate from the list of candidates to a different stage of the plurality of stages.

19. The system of claim 15 wherein the operations further comprise:
displaying, for each stage of the plurality of stages, a count of candidates associated with the stage; and
displaying, for one or more stages of the plurality of stages, a target number of candidates for each of the one or more stages.

20. The system of claim 15 wherein when the selected stage is an applicants stage, wherein the stage-specific action is a schedule interview stage-specific action, wherein the schedule interview stage-specific action is only displayed when the selected stage is the applicants stage, and wherein the interviewed stage-specific action is selectable by the user to send an interview request to a selected candidate from the list of candidates.
